(19) United States
(12) Patent Application Publication
(10) Pub. No.: US 2002/0108935 A1
(43) Pub. Date: Aug. 15, 2002

(54) Method and apparatus for cutting plastics using lasers

(76) Inventors: Robert D. Schad, North York (CA); Matthew Tai, Mississauga (CA); Ali R. Mortazavi, Richmond Hill (CA); Gordon Elliott, Etobicoke (CA); Leonard Migliore, Mountain View, CA (US)

Correspondence Address: HUSKY INJECTION MOLDING SYSTEMS, INC, 288 NORTH ROAD, MILTON, VT, 05468, US

(21) Appl. No.: 09/877,915

(22) Filed: Jun. 8, 2001

Related U.S. Application Data
(60) Provisional application No. 60/267,859, filed on Feb. 9, 2001.

(51) Int. Cl. B23K 26/38; B23K 26/067

(52) U.S. Cl. 219/121.67; 219/121.76; 219/121.77

(57) ABSTRACT

The present invention provides a process for removal of material from a substrate with a plurality of laser beams without substantially destroying or altering the chemical or physical characteristics of the remaining substrate.

### CROSS-REFERENCE TO RELATED APPLICATIONS

This application is related to copending application, entitled “System and Apparatus for Injection Molding Articles with Reduced Crystallization”, filed contemporaneously herewith and incorporated by reference.

### BACKGROUND OF THE INVENTION

1. Field of the Invention

This invention relates to the use of lasers to cut plastics. More particularly, this invention relates to the use of multiple laser beams focused on the same cut line of an object to produce an aesthetically improved cut in plastics.

2. Summary of the Prior Art

Precise and accurate laser cutting of plastic materials can be obtained by melting or vaporizing portions of a workpiece to obtain the desired shape by directing concentrations of light energy to the workpiece which may be either stationary or moving. For example the use of a laser in conjunction with a punch press is disclosed in U.S. Pat. No. 4,201,905. A workpiece, such as sheet of metal on a worktable is moved by grippers beneath a fixed laser, which is positioned to project a beam downwardly on a vertical axis. Pieces are cut from the workpiece by melting holes on a continuous line. This technique is generally limited to work on relatively thin sheets of stock.

Single lasers have been used in conjunction with turning operations. For example, U.S. Pat. No. 3,404,254 to Jones discloses a machine and technique for engraving the surface of a circular body by laser melting. A single laser beam is directed to the surface by a rotating cylinder. As the cylinder rotates the laser is translated axially of the cylinder to melt a continuous line in its surface. The cylinder is then rotated at sufficient speed to remove the melted localized portions from the cylinder by centrifugal force. While the desired results are achieved by engraving, the entire volume of stock removed is subjected to the laser energy.

In like manner, U.S. Pat. No. 4,170,726 to Okuda discloses directing a laser beam at selected portions of the surface of the workpiece tangentially of the path of rotation. Thereafter the molten material is removed by means of shaping mechanically of the workpiece

Similarly U.S. Pat. No. 3,499,136 to Nunnokhoven et al. describes a rotating body being balanced by removing the material from the body while it is rotating. The stock is removed by a laser that melts small particles of material from the rotating workpiece.

The use of a pulsed laser beam, as contrasted with a continuous laser beam, has the purpose of reducing the development of thermal gradients within the substrate material. Such thermal gradients would be of quite high value and they could cause fracturing in the substrate, especially if the substrate is relatively thick. Referring to FIG. 1a, during each laser pulse, because of the very high power of the laser light, sublimation gases are formed and they expand very rapidly. This causes a small explosion at each point of impact of the laser light beam on the substrate. Because of this, it is undesirable to superimpose a plurality of laser light pulses at the same location on the substrate, especially for piercing through the material from one side to the other side. The repeated explosions would cause microscopic fractures that would leave the substrate vulnerable to subsequent mechanical stresses. Further, mechanical stresses within the material itself would occur at the time of each explosion. These weaknesses would prevent the substrate from even passing standard inspection tests.

Referring to FIG 1b, on the other hand, applying only a single laser light pulse to a particular spot on the surface of the substrate reduces the damage to the substrate. To pierce the substrate by only a single laser light pulse, the power of each laser pulse is selected to be related to the material of which the substrate is comprised and to the thickness of the substrate so that a single pulse makes the through hole.

The damage to the substrate is greatest at the initial hole through the substrate. Also, the first hole tends to have a ragged or burred edge. To produce a neater cut line, where possible, the beam of laser light starts to drill through the substrate at a zone which is intended to be removed or cut away by the pulsed laser beam. The initially drilled hole becomes a line of partially overlapping holes and produces an elongated cut through path.

The present invention provides a novel process for piercing a substrate with a laser without substantially destroying or altering the chemical or physical characteristics of the substrate. As a result, after the substrate has been pierced, its use is not later compromised or restricted.

### SUMMARY OF THE INVENTION

The primary objective of the present invention is to provide a method and apparatus for processing materials using a laser.

Another object of the present invention is to provide a method and apparatus for processing a laser in a high speed production environment.

Another object of the present invention is to utilize a laser to remove stock from a workpiece to obtain a desired configuration without substantially altering the physical, mechanical or chemical properties of the workpiece.

Still another object of the present invention is to utilize at least two laser beams focused on the same cut line to produce a high quality cut.

Yet another object of the present invention is to provide a method and apparatus for the convenient economic, rapid production of a cut line in a work piece.

The foregoing objects are achieved by providing at least two spaced-apart laser beams, focused along the same cut line of a work piece. The workpiece and the laser beams are moved relative to one another to cause the controlled removal of material from the workpiece. The spacing between the laser beams is provided to allow for the clear unobstructed communication of the laser beam to the workpiece. Each laser beam removes a predetermined amount of material from the workpiece to preclude undesired damage to the workpiece such that when the workpiece is completely cut through, a high quality cut line is produced. To further enhance the quality of the laser beam cut, auxiliary inert pressurized gas may be directed at the cut line to reduce the deleterious effects of laser beam cuts known in the art.

Further objections and advantages of the present invention will appear hereinbelow.

### BREIF DESCRIPTION OF THE DRAWINGS

FIG. 1a is a depiction of a laser cutting a substrate in accordance with the prior art;

FIG. 1b is a depiction of a laser cutting a through hole in a substrate in accordance with the prior art;

FIG. 2 is a simplified isometric view of a preferred embodiment in accordance with the present invention;

FIG. 3 is a simplified isometric view of another preferred embodiment in accordance with the present invention;

FIG. 4 is a simplified isometric view of another preferred embodiment in accordance with the present invention;

FIGS. 5a-5d is a series of figures showing the laser cutting process as a workpiece passes by a series of laser beams.

### DETAILED DESCRIPTION OF THE PREFERRED EMBODIMENTS

Unlike laser cutting of metals, the cutting of non-metals is generally an easier to perform application because most plastics absorb the lower cost/watt CO2 laser light (10.6 μm) more efficiently. This assures effective cutting at high speeds with modest laser output power. The end results, however, run the gamut from high-quality smooth-edged cuts to those that exhibit a gummy residue, an effect exhibited by many thermosetting plastics. Consequently, laser cutting of plastics, while a relatively straight-forward use of laser power, is very dependent on the specific plastic's properties and interaction with the laser.

One mechanism for cutting plastics is commonly referred to as vaporization cutting. Acrylics are the most common polymer cut by this technique where the laser beam power raises the material to the boiling point and a narrow kerf cut results from material vaporization. Assist gas, usually argon, will blow excess vaporized material away from the beam path, eliminating beam absorption, which in polymers such as plexiglass, results in a sooty deposit. Under the microscope some thermally induced microcracks may be present but are not a great concern.

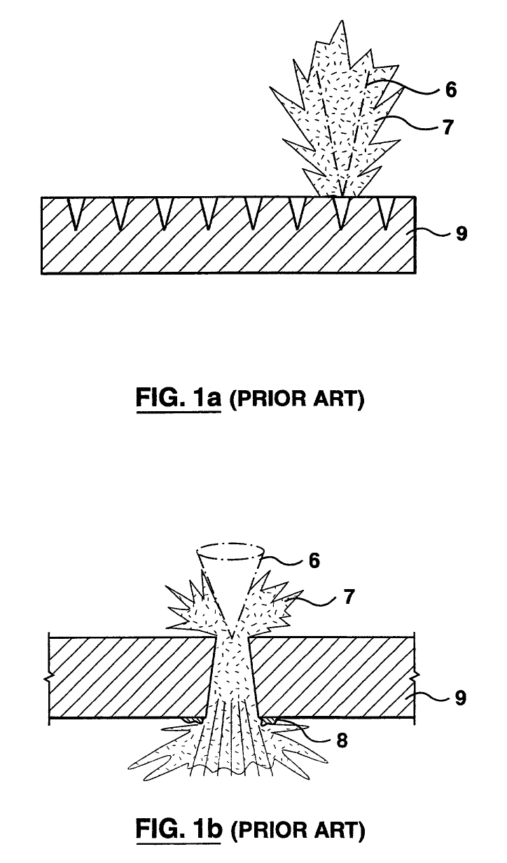

Referring to FIGS. 1a and 1b, which depicts the use of a laser beam 6 for removal of material from a substrate 9. FIG. 1a shows a pulsing laser beam 6 impinging on the surface of the substrate 9 to remove material from the substrate 9 at some predetermined depth. As the laser beam 6 strikes the substrate 9, material from the substrate is vaporized and creates a cloud 7 of dust and vapor. If the laser beam 6 is pulsed quickly enough, and in close proximity to the previous point of impingement, the cloud 7 will obstruct the clean transmission of the laser beam 6 and degrade the efficiency of material removal from the substrate 9. Prior art systems have been known to use forced air along the substrate to remove the cloud from in front of the laser beam.

FIG. 1b depicts the use of a single laser beam 7 to create a through hole in a substrate 9. Similar to FIG. 1a, material is vaporized by the laser beam and creates a cloud 7 of dust and vapor. In addition, as the laser beam 7 breaks through the substrate 9, a collection 8 of re-solidified material will form, commonly known as “dross”, that will require secondary operations to remove. It should also be noted that the hole created by the laser beam is not perfectly cylindrical, but is in fact, tapered along the thickness of the substrate 9. This is created by the fact that all laser beams diverge as the distance from the focal length increases. In many applications, this slight taper would be unacceptable.

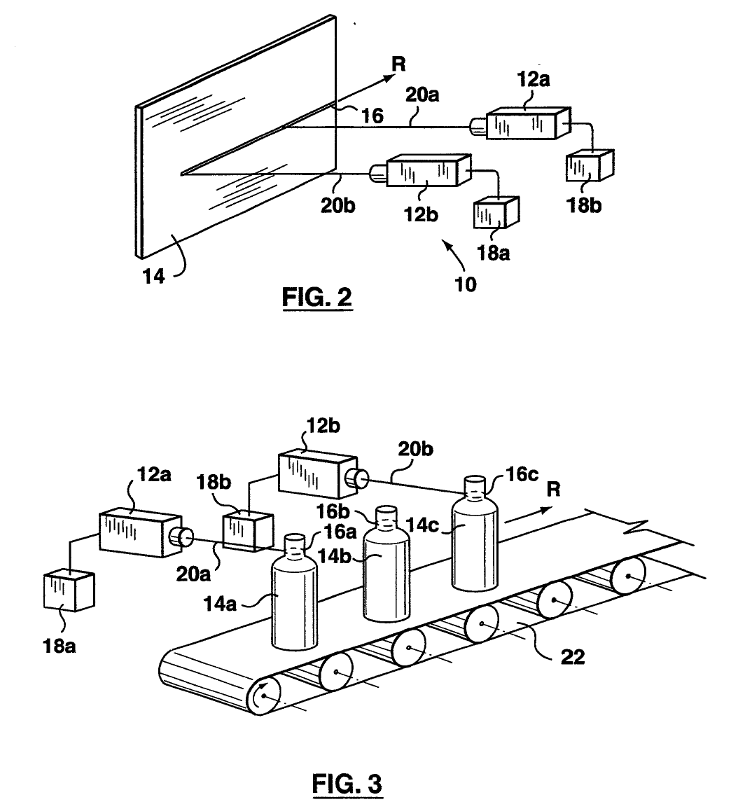

Now referring to FIG. 2, where a simplified isometric view of a preferred embodiment 10 of the present invention is shown. A pair of spaced apart lasers 12a and 12b transmit a focused laser beam 20a and 20b respectively at a predetermined location on a workpiece 14. In this figure, and not by way of limitation, the workpiece is shown as a substantially plate like member having a relatively thin cross-section. The workpiece 14 is moved relative to the laser beams 20a and 20b at a predetermined rate (denoted as R in the figure) such that a single cut line 16 is formed in the workpiece 14. In the preferred embodiment, the cut line 16 will require little or no secondary operations to remove unwanted material from around the cut line 16.

As shown in FIG. 2, laser beam 20b would strike the workpiece 14 first and remove a predetermined amount of material from the workpiece using the vaporization process previously described. The focal length and beam diameter of beam 20b would be adjusted to produce the cleanest cut possible. Power supply 18b, connected to laser 12b would also be adjusted to alter the power of the laser 20b in an effort to optimize the quality of the cut line 16.

As the workpiece continues to move, laser beam 20a will strike the workpiece 14 along cut line 16, but at a different depth than laser beam 20b due to the removal of material from the workpiece 14 by beam 20b. Again, the focal length and beam diameter will be adjusted to produce a clean cut completely through the workpiece 14. The separation distance between the beams 20a-20b is a function of workpiece material and they are placed so that the beam 20a will not be affected by the vaporized material/cloud caused by beam 20b. To further increase cut quality, an inert gas such as argon may be blown along the cut line to propel the vaporized particles away from the workpiece.

Laboratory testing has shown that there is a direct correlation between laser power, beam spot size, beam focal length, laser beam wavelength and the rate of motion of the workpiece on the quality of the cut. Each of these parameters needs to be adjusted to obtain a clean cut through the workpiece.

Now referring to FIG. 3 (where like feature have like numerals), an alternative exemplicative embodiment of the present invention is shown. In this embodiment, a pair of spaced apart lasers 12a and 12b each direct a focused laser beam 20a and 20b on a plurality of moving workpieces 14a-14c to produce a plurality of cut lines 16a-16c respectively. A conveyor 22 or the like is used to move the workpieces 14a-14c successively past each laser beam as shown in the figure. This embodiment represents a typical factory floor set up for the rapid production of workpieces, for example, plastic containers. Power to the lasers 12a and 12b is provided for and adjusted by a pair of power supplies 18a and 18b respectively.

Similar to the embodiment described in FIG. 2, each laser beam 20a and 20b is adjusted to remove a predetermined amount of material along the cut line 16a-16c. While this embodiment shows the use of only two lasers, depending on the workpiece material and the speed of the conveyor, more lasers may easily be required to effect a clean, high quality cut. By using a plurality of optimized lasers, each focused along the same cut line, problems associated with laser cutting such as burn marks, formation of bubbles and dross is substantially eliminated.

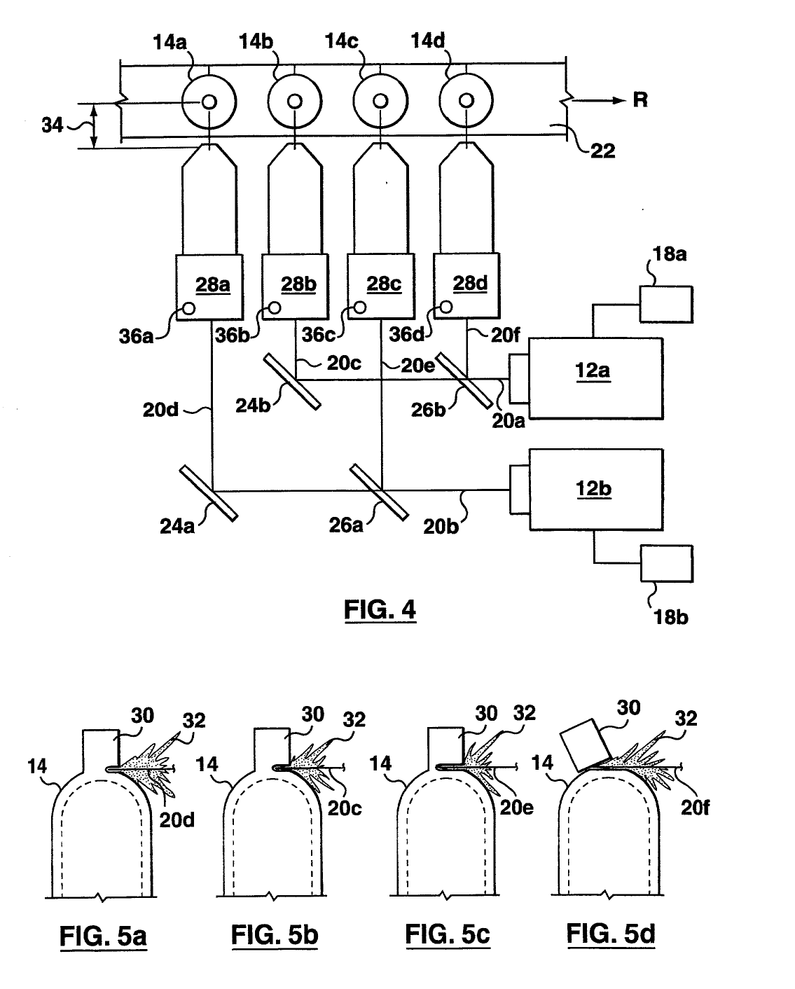

Referring to FIG. 4, (where like features have like numerals) another exemplicative embodiment of the present invention is shown where two lasers 12a and 12b direct a pair of laser beams 20a and 20b respectively which are then further split into four laser beams 20c, 20d, 20e and 20f. Laser beam 20b is directed first at a beam splitter 26b which produces two equally powered laser beams 20e and 20d. Laser beam 20e is reflected at substantially 90 degrees to beam 20b and transmitted to a focusing lens 28c which focuses and transmits beam 20e to workpiece 14c. Laser beam 20d is transmitted to fully reflective mirror 24a which reflects the beam 20d substantially 90 degrees to focusing lens 28a. Beam 20d is then further communicated to workpiece 14a. Beam splitter 26a and 26b each split the laser beams 20a and 20b such that half the power is reflected and the other half is further communicated to fully reflective mirrors 24a and 24b respectively.

Laser beam 20a is similarly split by beam splitter 26b thereby forming beams 20f and 20c, each of which are communicated to focusing lens 28d and 28b respectively. Beams 20c and 20f are then further communicated to workpiece 14b and 14d respectively. Adjustment knobs 36a-36d are provided on each focusing lens 28a-28d respectively to allow for the adjustment of each laser beam to provide an optimized cut on the workpieces. A conveyor 22 or the like moves the workpieces 14a-14d past each beam at a predetermined rate R.

Thus, in this embodiment, each laser 12a and 12b provides two spaced apart laser beams directed at the same cut line of a workpiece as it moves along the conveyor 22. Each beam(20c-20f) is focused and adjusted to remove a predetermined amount of material from the workpiece to produce a substantially clean cut in the workpiece where secondary cleaning operations has been eliminated or substantially reduced.

FIGS. 5a-5d show a time lapse depiction of the formation of a clean cut as nub 30 is removed from workpiece 14 as it successively passes by each laser beam in the apparatus of FIG. 4. Referring to FIG. 5a, as workpiece 14 passes by beam 20d, a predetermined amount of material is vaporized and removed from the workpiece 14. A cloud 32 of vaporized material forms at the instant the beam 20d strikes the workpiece 14. The depth and location of the cut is controlled by adjusting the laser beam power, the focal length, the spot size and the speed of the conveyor 22 such that the deleterious effects of the laser cut is eliminated or substantially reduced.

Now referring to FIG. 5b, at a predetermined distance from beam 20d, beam 20c will strike the workpiece 14 along the same cut line as the previous beam. Here again, beam 20c will remove a predetermined amount of material from the workpiece and create a deeper cut into the workpiece 14. Cloud 32, which was formed by the previous beam, will have dissipated sufficiently enough to allow for beam 20c to stay focused on the desired cut line, thereby producing a clean cut.

FIG. 5c shows the same workpiece 14 as it aligns with beam 20e. Yet again, the focused beam 20e strikes the workpiece 14 along the same cut line and removes a predetermined amount of material. Once again, the cloud 32 formed by the previous beam has dissipated enough to allow for the formation of a clean cut at the desired location.

FIG. 5d shows the workpiece 14 at the instant it aligns with beam 20f. In this embodiment, the remaining material between the workpiece 14 and the nub 30 is completely removed. The workpiece 14 is thus provided with a cleanly cut edge that requires little or no secondary cleaning operations.

Laboratory testing has shown that some of the vaporized material will tend to re-deposit on the surface of the workpiece. Various methods, well known in the art, may be employed to reduce or substantially eliminate this phenomenon. Such methods include blowing a gas along the cut line, electrically charging the workpiece to repel the vaporized material, brushes that mechanically wipe the workpiece and placing a screen around the workpiece have been commonly used in varying degrees. The embodiments describe herein fully contemplate the use of all such methods.

It is to be understood that the invention is not limited to the illustrations described herein, which are deemed to illustrate the best modes of carrying out the invention, and which are susceptible to modification of form, size, arrangement of parts and details of operation. The invention is intended to encompass all such modifications, which are within its spirit and scope as defined by the claims.

What is claimed is:

1. An apparatus for removing material from a workpiece comprising:
at least one laser for the communication of a plurality of laser beams to said workpiece along a common cut line,
a motive force for moving said workpiece relative to said plurality of laser beams at a predetermined rate,
wherein each said plurality of laser beams is spaced apart at a predetermined interval to effect removal of material from said workpiece.

2. The apparatus of claim 1 wherein said workpiece is made from a material selected from the group consisting of thermoplastic, rubber, glass, ceramic and metal.

3. The apparatus of claim 1 wherein each of said plurality of laser beams is further comprised of an independently adjustable focal length.

4. The apparatus of claim 1 wherein each of said plurality of laser beams is further comprised of an independently adjustable spot size.

5. The apparatus of claim 1 wherein each of said plurality of laser beams is further comprised of an independently adjustable pulse frequency.

6. The apparatus of claim 1 wherein each of said plurality of laser beams is further comprised of an independently adjustable power supply for adjusting the power of each said plurality of laser beams.

7. The apparatus of claim 1 wherein each of said plurality of lasers is provided on the same side of said workpiece.

8. The apparatus of claim 1 wherein said motive force is adjustable for the selection of said predetermined rate.

9. The apparatus of claim 1 further comprising a plurality of focusing lenses, each of said focusing lenses receiving one of said plurality of laser beams and communicating said laser beam to a predetermined location on said workpiece.

10. The apparatus of claim 9, wherein each of said plurality of said focusing lenses provides for the adjustment of the focal length of said laser beams.
